(19) United States
(12) Patent Application Publication
(10) Pub. No.: US 2025/0136631 A1
(43) Pub. Date: May 1, 2025

(54) METHODS FOR PURIFYING BIS (ARENE) NICKEL COMPLEXES AND RELATED PRODUCTS

(71) Applicant: ENTEGRIS, INC., Billerica, MA (US)

(72) Inventor: Drew Michael Hood, Newtown, CT (US)

(21) Appl. No.: 18/930,895

(22) Filed: Oct. 29, 2024

Related U.S. Application Data
(60) Provisional application No. 63/546,515, filed on Oct. 30, 2023.
(60) Provisional application No. 63/546,518, filed on Oct. 30, 2023.

(51) Int. Cl. C07F 17/02; B01D 11/04; B01D 37/00

(52) U.S. Cl. CPC C07F 17/02; B01D 11/0492; B01D 37/00

(57) ABSTRACT

Methods for purifying bis (arene) nickel complex products and related products are provided. A method comprises obtaining a crude mixture comprising a bis (arene) nickel complex and at least one impurity; obtaining a separation solvent; distilling the separation solvent to generate a distilled separation solvent; filtering the crude mixture with the distilled separation solvent so as to obtain a filtrate comprising the distilled separation solvent and at least a portion of the bis (arene) nickel complex; and removing the separation solvent from the filtrate so as to obtain a purified bis (arene) nickel complex product.

### CROSS-REFERENCE TO RELATED APPLICATIONS

This application claims the benefit under 35 USC 119 of U.S. Provisional Patent Application No. 63/546,515, filed Oct. 30, 2023, and 63/546,518 filed on Oct. 30, 2023, the disclosure of each is hereby incorporated herein by reference in its entirety.

### FIELD

The present disclosure relates to methods of purifying bis (arene) nickel complexes and related products.

### BACKGROUND

Preparing high purity bis (arene) nickel complexes, for example, for use as nickel precursors, for preparing nickel silicates, as atomic layer deposition precursors, or other similar processes, remains an ongoing challenge.

### SUMMARY

Some embodiments of the present disclosure related to a method of purifying a bis (arene) nickel complex. In some embodiments, the method comprises obtaining a crude mixture comprising a bis (arene) nickel complex and at least one impurity; obtaining a separation solvent; distilling the separation solvent to generate a distilled separation solvent; filtering the crude mixture with the distilled separation solvent so as to obtain a filtrate comprising the distilled separation solvent and at least a portion of the bis (arene) nickel complex; and removing the separation solvent from the filtrate so as to obtain a purified bis (arene) nickel complex product.

Some embodiments of the present disclosure relate to a bis (arene) nickel complex comprising a purity of 95% or greater. In some embodiments, the bis (arene) nickel complex is purified by solvent extraction.

### DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 is a flowchart of a method of purifying a bis (arene) nickel complex, according to some embodiments.

FIG. 2 is graph showing thermographic analysis of a bis (arene) nickel complex as received compared a bis (arene) nickel complex purified according to some embodiments of the present disclosure.

FIG. 3 is graph showing percentage decomposition at 75° C. over 32 days of an as-received bis (arene) nickel complex compared a bis (arene) nickel complex purified according to some embodiments.

FIG. 4 is graph showing thermographic analysis, after storage at 75° C. for 32 days, of an as-received bis (arene) nickel complex compared a bis (arene) nickel complex purified according to some embodiments of the present disclosure.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure are intended to be illustrative, and not restrictive.

Any prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

For example, and without limitation, the present disclosure relates to methods of purifying bis (arene) nickel complexes and purified products obtained using methods of the present disclosure. Some embodiments further provide methods for purifying and/or removing impurities from crude mixtures and compositions comprising purified bis (arene) nickel complexes. Such purified bis (arene) nickel complexes are suitable for use as precursors for obtaining nickel products, such as nickel silicate products, for use as atomic layer deposition precursors or other similar processes.

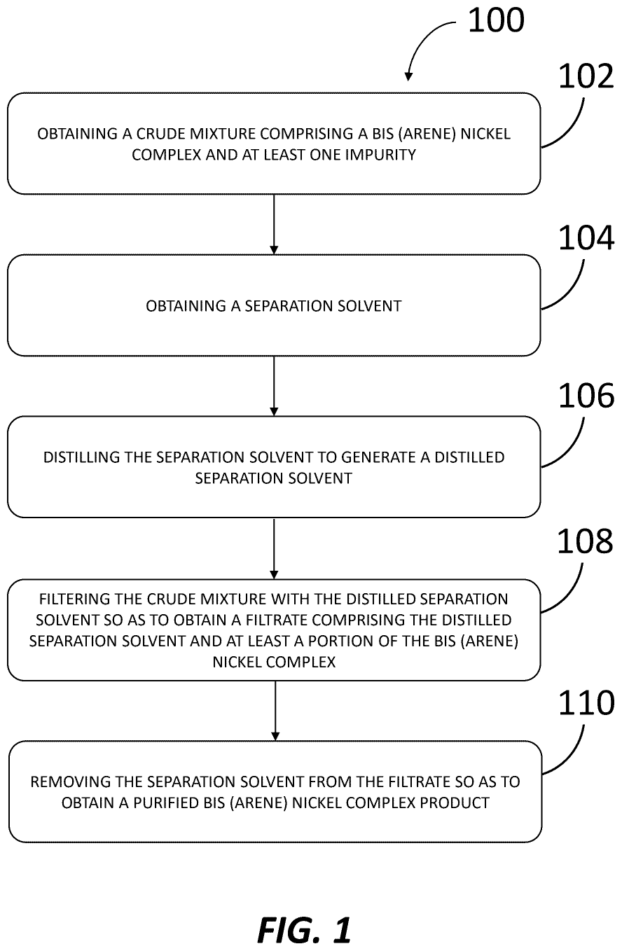

FIG. 1 depicts a schematic representation of a method according to some embodiments. In some embodiments, the method 100 for purifying a bis (arene) nickel complex may comprise one or more of the following steps: a step 102 of obtaining a crude mixture comprising a bis (arene) nickel complex and at least one impurity, a step 104 of obtaining a distillation solvent, a step 106 of distilling the separation solvent to generate a distilled separation solvent, a step 108 of filtering the crude mixture with the distilled separation solvent so as to obtain a filtrate comprising the distilled separation solvent and at least a portion of the bis (arene) nickel complex, and a step 110 of removing the separation solvent from the filtrate so as to obtain a purified bis (arene) nickel complex product.

At step 102, in some embodiments, the crude mixture comprises a solid reagent. In some embodiments, the solid reagent comprises at least one of a bis (arene) nickel complex. In some embodiments, the solid reagent comprises a nickelocene compound. In some embodiments, the bis (arene) nickel complex comprises a bis (cyclopentadiene) nickel (Cp₂Ni) complex. In some embodiments, the bis (arene) nickel complex comprises a bis (benzene) nickel complex, a bis (toluene) nickel complex, a bis (xylene) nickel complex, a bis (butyltoluene) nickel complex, a bis (ethyl methyl benzene) nickel complex, a bis (ethyl methylbenzene) nickel complex, a bis (isopropyl methyl benzene) nickel complex, a bis (butyl methylbenzene) nickel complex, a bis (mesitylene) nickel complex, a bis (pseudocumene) nickel complex, a bis (durene) nickel complex, a bis (methylbenzene) nickel complex, a bis (dimethylbenzene) nickel complex, a bis (trimethylbenzene) nickel complex, a bis (ethylbenzene) nickel complex, a bis (1,4-diethylbenzene) nickel complex, a bis (triethylbenzene) nickel complex, a bis (propylbenzene) nickel complex, a bis (butylbenzene) nickel complex, a bis (iso-butylbenzene) nickel complex, a bis (sec-butylbenzene) nickel complex, a bis (t-butylbenzene) nickel complex, a bis (hexylbenzene) nickel complex, a bis (styrene) metal complex, a bis (naphthalene) nickel complex, a bis (anthracene) nickel complex, a bis (phenanthrene) nickel complex, a bis (biphenyl) nickel complex, a bis (terphenyl) nickel complex, a bis (methylnaphthalene) nickel complex, a bis (biphenylene) nickel complex, a bis (dimethylnaphthalene) nickel complex, a bis (methylanthracene) nickel complex, a bis (4,4′-dimethylbiphenyl) nickel complex, a bis (bibenzyl) nickel complex, a bis (diphenylmethane) nickel complex, a bis (indene) nickel complex, a bis (fluorene) nickel complex, any isomer thereof, or any combination thereof.

In some embodiments, the bis (arene) nickel complex comprises bis (cyclopentadiene) nickel. In some embodiments, the bis (arene) nickel complex comprises bis (alkylcyclopentadiene) nickel, bis (methylcyclopentadiene) nickel, bis (ethylcyclopentadiene) nickel, bis (isopropylcyclopentadiene) nickel, bis (tert-butylcyclopentadiene) nickel, bis (pentamethylcyclopentadiene) nickel, any isomer thereof, or any combination thereof.

In some embodiments, the crude mixture comprises at least one impurity. In some embodiments, the crude mixture comprises 1% to 10% by weight of at least one impurity based on a total weight of the crude mixture, or any range or subrange between 1% and 10%. For example, in some embodiments, the mixture comprises 2% to 9%, 2% to 8%, 2% to 7%, 2% to 6%, 2% to 5%, 2% to 4%, 2% to 3%, 3% to 9%, 4% to 9%, 5% to 9%, 6% to 9%, 7% to 9%, or 8% to 9% by weight of at least one impurity based on a total weight of the crude mixture. In some embodiments, the at least one impurity is present in the crude mixture in an amount of at least 8.5%, 8.4%, 8.2%, 8%, 7.5%, 7%, 6.5%, 6%, 5.5%, 5%, 4.5%, 4%, 3.5%, 3%, 2.5%, or 2% by weight of the at least one impurity based on a total weight of the crude mixture. In some embodiments, the at least one impurity is detectable by nuclear magnetic resonance (NMR) spectroscopic analysis.

At step 104, in some embodiments, the separation solvent comprises at least one of alkanes, aromatics, or any combination thereof. In some embodiments, the separation solvent comprises an alkane. In some embodiments, the alkane comprises pentane, hexane, heptane, octane, nonane, decane, undecane, dodecane, any isomers thereof, or any combination thereof. In some embodiments, the alkane comprises pentane. In some embodiments, the alkane comprises hexane. In some embodiments, the alkane comprises octane. In some embodiments, the separation solvent an comprises aromatics. In some embodiments, the aromatic comprises benzene, toluene, ethylbenzene, benzyl alcohol, xylene, or mixed xylenes. In some embodiments, the aromatic comprises benzene. In some embodiments, the aromatic comprises toluene. In some embodiments, the aromatic comprises ethylbenzene. In some embodiments, the aromatic comprises benzyl alcohol. In some embodiments, the aromatic comprises xylene. In some embodiments, the aromatic comprises mixed xylenes. In some embodiments, the separation solvent comprises a solvent, wherein the solvent is unreactive or does not react with the nickel complex (e.g., bis (arene) nickel complex. In some embodiments, the solvent comprises at least one of an ether, a toluene, a tetrahydrofuran, a benzene, a hexane, a dichloromethane, or any combination thereof.

At step 106, in some embodiments, the separation solvent is distilled to generate a distilled separation solvent. In some embodiments, the distillation comprises heating the separation solvent in a first vessel to a first temperature. The first vessel may be configured to control temperature. The temperature of the first vessel may be controlled in any suitable manner. In some embodiments, a thermal jacket for heating is employed around the first vessel. In some embodiments, a ribbon heater is wound around the first vessel. In some embodiments, a block heater having a shape covering at least a major portion of the external surface of the first vessel is employed to heat the first vessel. In some embodiments, a resistive heater is employed to heat the first vessel. In some embodiments, a lamp heater is employed to heat the first vessel. In some embodiments, a heat transfer fluid at elevated temperature may be contacted with the exterior surface of the first vessel, to effect heating and/or cooling thereof. In some embodiments, the heating is conducted by infrared or other radiant energy being impinged on the first vessel. It is to be appreciated that other heating devices and assemblies, and other configurations and arrangements of the heater may be employed herein without departing from the scope of this disclosure.

In some embodiments, the first temperature is a temperature of 50° C. to 200° C., or any range or subrange between 50° C. and 200° C. In some embodiments, the first temperature is a temperature in a range of 60° C. to 200° C., 70° C. to 200° C., 80° C. to 200° C., 90° C. to 200° C., 100° C. to 200° C., 110° C. to 200° C., 120° C. to 200° C., 130° C. to 200° C., 140° C. to 200° C., 150° C. to 200° C., 160° C. to 200° C., 170° C. to 200° C., 180° C. to 200° C., or 190° C. to 200° C. In some embodiments, the first temperature is a temperature in a range of 50° C. to 190° C., 50° C. to 180° C., 50° C. to 170° C., 50° C. to 160° C., 50° C. to 150° C., 50° C. to 140° C., 50° C. to 130° C., 50° C. to 120° C., 50° C. to 110° C., 50° C. to 100° C., 50° C. to 90° C., 50° C. to 80° C., 50° C. to 70° C., or 50° C. to 60° C. In some embodiments, the first temperature is a temperature of 50° C., 55° C., 60° C., 65° C., 70° C., 75° C., 80° C., 85° C., 90° C., 95° C., 100° C., 105° C., 110° C., 115° C., 120° C., 125° C., 130° C., 135° C., 140° C., 145° C., 150° C., 155° C., 160° C., 165° C., 170° C., 175,° C., 180° C., 185° C., 190° C., 195° C., or 200° C.

In some embodiments, the heated separation solvent is vaporized and collected in a second vessel as a distilled separation solvent. In some embodiments, the method comprises condensing the vaporized separation solvent at a second temperature and second pressure. In some embodiments, condensing comprises applying at least one condition sufficient to condense at least a portion of the vaporized separation solvent in the second vessel. The at least one condition may be applied to at least one of the second vessel or the vaporized separation solvent, or any combination thereof. In some embodiments, the condensing comprises cooling the second vessel and/or the vaporized separation solvent to a temperature sufficient to condense at least a portion of the separation solvent in the second vessel. In some embodiments, the condensing comprises pressurizing the second vessel at or to a pressure sufficient to condense at least a portion of the vaporized separation solvent in the second vessel. In some embodiments, the condensing comprises depressurizing the second vessel at or to a pressure sufficient to condense at least a portion of the vaporized separation solvent in the second vessel. The condensing may comprise cooling the second vessel and/or the separation solvent. In some embodiments, the condensing may comprise pressurizing or depressurizing the second vessel.

In some embodiments, at least a portion of the vaporized separation solvent is condensed.

The second vessel may be configured to control temperature. The temperature of the second vessel may be controlled in any suitable manner. In some embodiments, a thermal jacket for cooling is employed around the second vessel. In some embodiments, the second vessel is cooled by a fluid, a fan, a direct thermoelectric device, or any combination thereof. It is to be appreciated that other cooling devices and assemblies, and other configurations and arrangements of the cooler may be employed herein without departing from the scope of this disclosure.

In some embodiments, the second temperature is a temperature in a range of 50° C. to 200° C. or any range or subrange between 50° C. and 200° C. In some embodiments, the second temperature is a temperature of 60° C. to 200° C., 70° C. to 200° C., 80° C. to 200° C., 90° C. to 200° C., 100° C. to 200° C., 110° C. to 200° C., 120° C. to 200° C., 130° C. to 200° C., 140° C. to 200° C., 150° C. to 200° C., 160° C. to 200° C., 170° C. to 200° C., 180° C. to 200° C., or 190° C. to 200° C. In some embodiments, the second temperature is a temperature in a range of 50° C. to 190° C., 50° C. to 180° C., 50° C. to 170° C., 50° C. to 160° C., 50° C. to 150° C., 50° C. to 140° C., 50° C. to 130° C., 50° C. to 120° C., 50° C. to 110° C., 50° C. to 100° C., 50° C. to 90° C., 50° C. to 80° C., 50° C. to 70° C., or 50° C. to 60° C. In some embodiments, the second temperature is a temperature of 50° C., 55° C., 60° C., 65° C., 70° C., 75° C., 80° C., 85° C., 90° C., 95° C., 100° C., 105° C., 110° C., 115° C., 120° C., 125° C., 130° C., 135° C., 140° C., 145° C., 150° C., 155° C., 160° C., 165° C., 170° C., 175,° C., 180° C., 185° C., 190° C., 195° C., or 200° C.

The first vessel and/or second vessel may be configured to control pressure. The pressure of the first vessel and/or second vessel may be controlled in any suitable manner. In some embodiments, a gas inlet line is fluidly coupled to the first vessel and/or second vessel. The gas inlet line may be configured to supply a pressurizing gas from a pressurizing gas source to the first vessel and/or second vessel. Control of the pressurizing gas into the first vessel and/or second vessel may be achieved by at least one of pressure regulators, needle valves, mass flow controllers, downstream pressure controllers, or any combination thereof. In some embodiments, the pressurizing gas comprises an inert gas. In some embodiments, the inert gas comprises at least one of helium, argon, nitrogen, or any combination thereof. In some embodiments, a vacuum line is fluidly coupled to the first vessel and/or second vessel. The vacuum line may be configured to apply a vacuum to the first vessel and/or second vessel. In some embodiments, the pumping speed is controlled by butterfly valves. It will be appreciated that other mechanisms for controlling the pressure of the first vessel and/or the second vessel may be employed herein without departing from the scope of this disclosure.

At step 108, in some embodiments, the method further comprises filtering the crude mixture with the distilled separation solvent so as to obtain a filtrate comprising the distilled separation solvent and at least a portion of the bis (arene) nickel complex.

In some embodiments, as at least a portion of the distilled separation solvent in a vapor phase undergoes condensing, the distilled separation solvent contacts the crude mixture. For example, in some embodiments, the step 108 comprises contacting the crude mixture with the distilled separation solvent, which may be present in at least one of a vapor phase, a gas phase, a liquid phase, or any combination thereof. In some embodiments, the contacting comprises bringing the distilled separation solvent into immediate or close proximity, or into direct physical contact. In some embodiments, the distilled separation solvent is present at an elevated temperature (i.e., a temperature above room temperature), so as to facilitate extraction of the at least one impurity into the distilled separation solvent. In some embodiments, the filtering comprises providing the crude mixture over a fritted filter and flowing the distilled separation solvent over the crude mixture and through the fritted filter. In some embodiments, the flowing comprises delivering the distilled separation solvent to crude mixture over the fritted filter. In some embodiments, the flowing comprises discharging the distilled separation solvent to crude mixture over the fritted filter. In some embodiments, the flowing comprises feeding the distilled separation solvent to crude mixture over the fritted filter. In some embodiments, the flowing comprises injecting the distilled separation solvent to crude mixture over the fritted filter. In some embodiments, the flowing comprises passing the distilled separation solvent to crude mixture over the fritted filter. In some embodiments, the flowing comprises pumping the distilled separation solvent to crude mixture over the fritted filter. In some embodiments, the flowing comprises supplying the distilled separation solvent to crude mixture over the fritted filter. It will be appreciated that the manner in which the distilled separation solvent is provided to crude mixture over the fritted filter is not particularly limited and may include any suitable technique known in the art.

At step 110, in some embodiments, the separation solvent is removed from the filtrate to obtain a purified bis (arene) nickel complex.

In some embodiments, the removing comprises a technique for separating the separation solvent from the purified bis (arene) nickel complex. For example, in some embodiments, a cannula is employed for the removing the separation solvent. In some embodiments, the removing comprises decanting the separation solvent to obtain the purified bis (arene) nickel complex. In some embodiments, the removing comprises pipetting the separation solvent to obtain the purified bis (arene) nickel complex. In some embodiments, the removing comprises pouring the separation solvent out to obtain the purified bis (arene) nickel complex. In some embodiments, the removing comprises transferring the separation solvent to another reaction vessel to obtain the purified bis (arene) nickel complex. In some embodiments, the removing comprises evaporating the separation solvent to obtain the purified bis (arene) nickel complex.

Some embodiments relate to a purified bis (arene) nickel complex. In some embodiments, the purified bis (arene) nickel complex is obtained by solvent extraction.

In some embodiments, a purity of the bis (arene) nickel complex (e.g., bis (cyclopentadiene) nickel) is 95% to 99.9999%, or any range or subrange between 95% to 99.9999%. For example, in some embodiments, the purity of the bis (arene) nickel complex is 96% to 99.9999%, 97% to 99.9999%, 98% to 99.9999%, 99% to 99.9999%, 95% to 99.9%, 95% to 99.99%, or 95% to 99.999%. In some embodiments, the bis (arene) nickel complex comprises a purity of 95% or greater. In some embodiments, the bis (arene) nickel complex comprises a purity of 95% or greater when purified by solvent extraction. In some embodiments, the bis (arene) nickel complex comprises a purity of 98% or greater. In some embodiments, the bis (arene) nickel complex comprises a purity of 98% or greater when purified by solvent extraction.

In some embodiments, the purified bis (arene) nickel complex product comprises less than 1.3% by weight of at least one impurity based on a total weight of the purified bis (arene) nickel complex product. For example, in some embodiments, the purified bis (arene) nickel complex product comprises less than: 1.2%, 1.1%, 1.0%, 0.9%, 0.8%, 0.7%, 0.6%, 0.5%, 0.4%, 0.3%, 0.2%, or 0.1% by weight of at least one impurity based on a total weight of the purified bis (arene) nickel complex product.

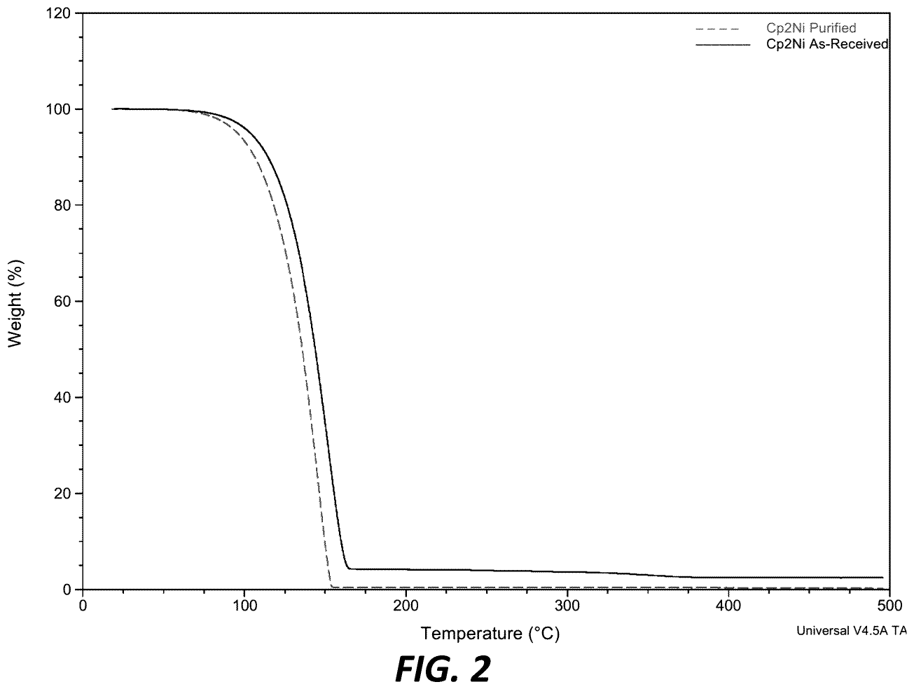

As shown in FIG. 2, purified bis (cyclopentadiene) nickel complex shows an improved profile when analyzed by thermogravimetric analysis (TGA).

In some embodiments, the purified bis (arene) nickel complex product is stable over 32 days at a temperature of 75° C.

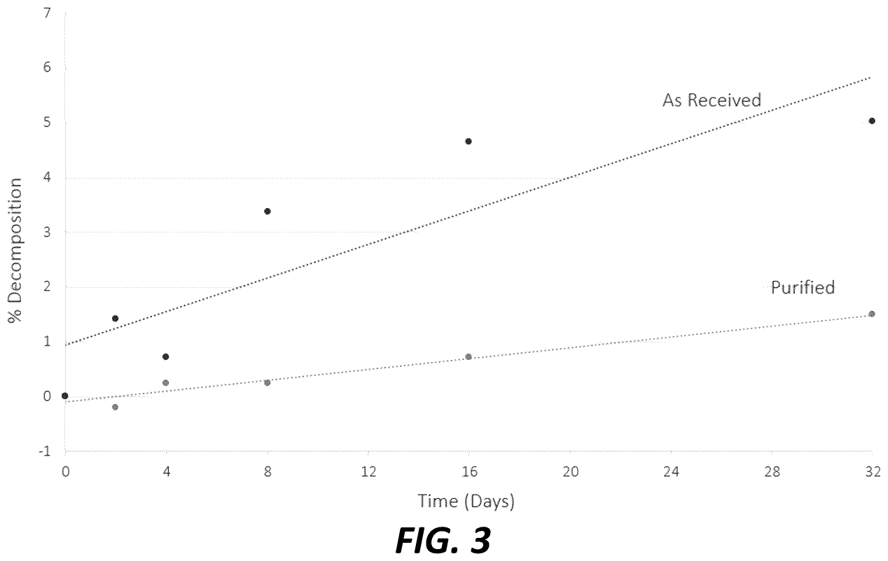

As shown in FIG. 3, the purified bis (arene) nickel complex product of the present disclosure shows a decomposition of less than 5.0%, which is lower than the decomposition of the of the as-received bis (arene) nickel complex prior to purification according to embodiments of the present disclosure.

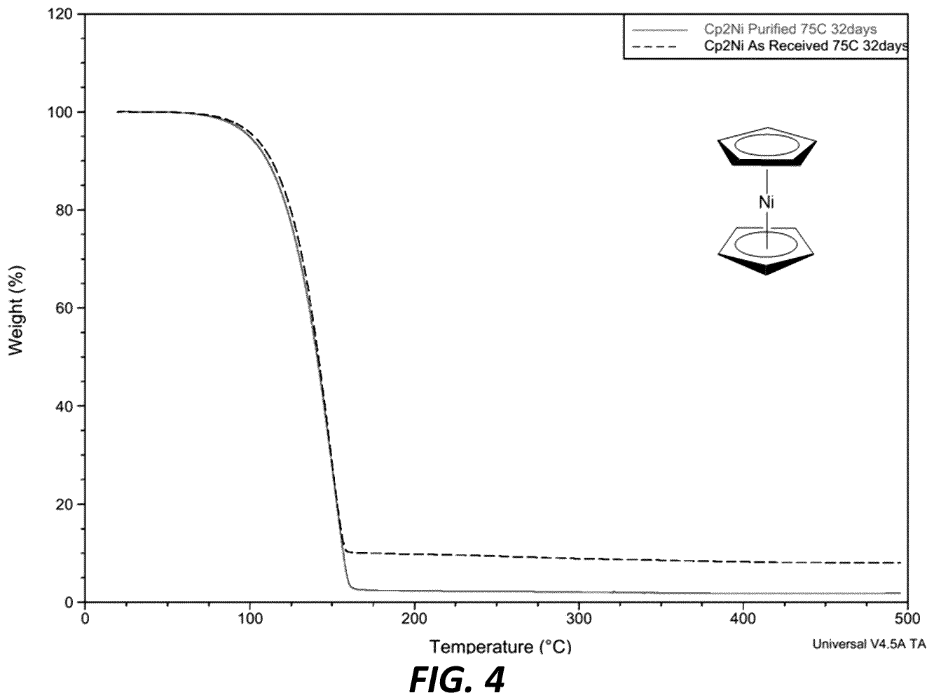

As shown in FIG. 4, after storage at 75° C. for 32 days the purified bis (arene) nickel complex of the present disclosure shows improved TGA curves compared to the as-receive bis (arene) nickel complex stored at 75° C. for 32 days.

### Aspects

Various Aspects are described below. It is to be understood that any one or more of the features recited in the following Aspect(s) can be combined with any one or more other Aspect(s).

Aspect 1. A method comprising:
obtaining a crude mixture comprising a bis (arene) nickel complex and at least one impurity;
obtaining a separation solvent;
distilling the separation solvent to generate a distilled separation solvent;
filtering the crude mixture with the distilled separation solvent so as to obtain a filtrate comprising the distilled separation solvent and at least a portion of the bis (arene) nickel complex; and
removing the separation solvent from the filtrate so as to obtain a purified bis (arene) nickel complex product.

Aspect 2. The method according to Aspect 1, further comprising reheating the filtrate to regenerate the distilled separation solvent.

Aspect 3. The method according to any one of Aspects 1-2, further comprising repeating filtering the crude mixture with the distilled separation solvent so as to further extract the bis (arene) nickel complex from the crude mixture.

Aspect 4. The method according to any one of Aspects 1-3, wherein the purified bis (arene) nickel complex product has less than 1.2% of the at least one impurity.

Aspect 5. The method according to any one of Aspects 1-4, wherein the at least one impurity is detectable by nuclear magnetic resonance (NMR) spectroscopic analysis.

Aspect 6. The method according to any one of Aspects 1-5, wherein the purified bis (arene) nickel complex product is stable over 32 days at a temperature of 75° C.

Aspect 7. The method according to any one of Aspects 1-6, wherein the separation solvent comprises alkanes or aromatics.

Aspect 8. The method according to Aspect 7, wherein the alkanes comprise pentane, hexane, heptane, octane, nonane, decane, undecane, dodecane, any isomers thereof, or any combination thereof.

Aspect 9. The method according to Aspect 7, wherein the aromatics comprise benzene, toluene, ethylbenzene, benzyl alcohol, xylene, or mixed xylenes.

Aspect 10. The method according to any one of Aspects 1-9, wherein the bis (arene) nickel complex comprises a bis (cyclopentadienyl) nickel complex, a bis (benzene) nickel complex, a bis (toluene) nickel complex, a bis (xylene) nickel complex, a bis (butyltoluene) nickel complex, a bis (ethyl methyl benzene) nickel complex, a bis (ethyl methylbenzene) nickel complex, a bis (isopropyl methyl benzene) nickel complex, a bis (butyl methylbenzene) nickel complex, a bis (mesitylene) nickel complex, a bis (pseudocumene) nickel complex, a bis (durene) nickel complex, a bis (methylbenzene) nickel complex, a bis (dimethylbenzene) nickel complex, a bis (trimethylbenzene) nickel complex, a bis (ethylbenzene) nickel complex, a bis (1,4-diethylbenzene) nickel complex, a bis (triethylbenzene) nickel complex, a bis (propylbenzene) nickel complex, a bis (butylbenzene) nickel complex, a bis (iso-butylbenzene) nickel complex, a bis (sec-butylbenzene) nickel complex, a bis (t-butylbenzene) nickel complex, a bis (hexylbenzene) nickel complex, a bis (styrene) metal complex, a bis (naphthalene) nickel complex, a bis (anthracene) nickel complex, a bis (phenanthrene) nickel complex, a bis (biphenyl) nickel complex, a bis (terphenyl) nickel complex, a bis (methylnaphthalene) nickel complex, a bis (biphenylene) nickel complex, a bis (dimethylnaphthalene) nickel complex, a bis (methylanthracene) nickel complex, a bis (4,4′-dimethylbiphenyl) nickel complex, a bis (bibenzyl) nickel complex, a bis (diphenylmethane) nickel complex, a bis (indene) nickel complex, a bis (fluorene) nickel complex, or any isomer thereof.

Aspect 11. The method according to any one of Aspects 1-10, wherein the bis (arene) nickel complex comprises bis (cyclopentadiene) nickel.

Aspect 12. The method according to any one of Aspects 1-11, wherein the bis (arene) nickel complex comprises bis (alkylcyclopentadiene) nickel, bis (methylcyclopentadiene) nickel, bis (ethylcyclopentadiene) nickel, bis (isopropylcyclopentadiene) nickel, bis (tert-butylcyclopentadiene) nickel, bis (pentamethylcyclopentadiene) nickel, or any isomer thereof.

Aspect 13. A bis (arene) nickel complex, comprising a purity of 95% or greater,
wherein the bis (arene) nickel complex is purified by solvent extraction.

Aspect 14. The bis (arene) nickel complex according to Aspect 13, wherein the solvent extraction comprises extraction by a separation solvent comprising alkanes or aromatics.

Aspect 15. The bis (arene) nickel complex according to any one of Aspects 13-14, wherein the solvent extraction comprises extraction by a separation solvent comprising pentane.

Aspect 16. The bis (arene) nickel complex according to any one of Aspects 13-15, wherein the purity is 98% or greater.

Aspect 17. The bis (arene) nickel complex according to any one of Aspects 13-16, comprising at least one impurity of 1.2% or less.

Aspect 18. The bis (arene) nickel complex according to Aspect 17, wherein the at least one impurity is detectable by nuclear magnetic resonance (NMR) spectroscopic analysis.

Aspect 19. The bis (arene) nickel complex according to any one of Aspects 13-18, wherein the bis (arene) nickel complex comprises bis (cyclopentadiene) nickel.

Aspect 20. The bis (arene) nickel complex of any one of Aspects 13-19, wherein the bis (arene) nickel complex comprises bis (alkylcyclopentadiene) nickel, bis (methylcyclopentadiene) nickel, bis (ethylcyclopentadiene) nickel, bis (isopropylcyclopentadiene) nickel, bis (tert-butylcyclopentadiene) nickel, bis (pentamethylcyclopentadiene) nickel, or any isomer thereof.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. A method comprising:
obtaining a crude mixture comprising a bis (arene) nickel complex and at least one impurity;
obtaining a separation solvent;
distilling the separation solvent to generate a distilled separation solvent;
filtering the crude mixture with the distilled separation solvent so as to obtain a filtrate comprising the distilled separation solvent and at least a portion of the bis (arene) nickel complex; and
removing the separation solvent from the filtrate so as to obtain a purified bis (arene) nickel complex product.

2. The method of claim 1, further comprising reheating the filtrate to regenerate the distilled separation solvent.

3. The method of claim 1, further comprising repeating filtering the crude mixture with the distilled separation solvent so as to further extract the bis (arene) nickel complex from the crude mixture.

4. The method of claim 1, wherein the purified bis (arene) nickel complex product has less than 1.2% of the at least one impurity.

5. The method of claim 1, wherein the at least one impurity is detectable by nuclear magnetic resonance (NMR) spectroscopic analysis.

6. The method of claim 1, wherein the purified bis (arene) nickel complex product is stable over 32 days at a temperature of 75° C.

7. The method of claim 1, wherein the separation solvent comprises alkanes or aromatics.

8. The method of claim 7, wherein the alkanes comprise pentane, hexane, heptane, octane, nonane, decane, undecane, dodecane, any isomers thereof.

9. The method of claim 7, wherein the aromatics comprise benzene, toluene, ethylbenzene, benzyl alcohol, xylene, or mixed xylenes.

10. The method of claim 1, wherein the bis (arene) nickel complex comprises a bis (cyclopentadienyl) nickel complex, a bis (benzene) nickel complex, a bis (toluene) nickel complex, a bis (xylene) nickel complex, a bis (butyltoluene) nickel complex, a bis (ethyl methyl benzene) nickel complex, a bis (ethyl methylbenzene) nickel complex, a bis (isopropyl methyl benzene) nickel complex, a bis (butyl methylbenzene) nickel complex, a bis (mesitylene) nickel complex, a bis (pseudocumene) nickel complex, a bis (durene) nickel complex, a bis (methylbenzene) nickel complex, a bis (dimethylbenzene) nickel complex, a bis (trimethylbenzene) nickel complex, a bis (ethylbenzene) nickel complex, a bis (1,4-diethylbenzene) nickel complex, a bis (triethylbenzene) nickel complex, a bis (propylbenzene) nickel complex, a bis (butylbenzene) nickel complex, a bis (iso-butylbenzene) nickel complex, a bis (sec-butylbenzene) nickel complex, a bis (t-butylbenzene) nickel complex, a bis (hexylbenzene) nickel complex, a bis (styrene) metal complex, a bis (naphthalene) nickel complex, a bis (anthracene) nickel complex, a bis (phenanthrene) nickel complex, a bis (biphenyl) nickel complex, a bis (terphenyl) nickel complex, a bis (methylnaphthalene) nickel complex, a bis (biphenylene) nickel complex, a bis (dimethylnaphthalene) nickel complex, a bis (methylanthracene) nickel complex, a bis (4,4′-dimethylbiphenyl) nickel complex, a bis (bibenzyl) nickel complex, a bis (diphenylmethane) nickel complex, a bis (indene) nickel complex, a bis (fluorene) nickel complex, or any isomer thereof.

11. The method of claim 1, wherein the bis (arene) nickel complex comprises bis (cyclopentadiene) nickel.

12. The method of claim 1, wherein the bis (arene) nickel complex comprises bis (alkylcyclopentadiene) nickel, bis (methylcyclopentadiene) nickel, bis (ethylcyclopentadiene) nickel, bis (isopropylcyclopentadiene) nickel, bis (tert-butylcyclopentadiene) nickel, bis (pentamethylcyclopentadiene) nickel, any isomer thereof, or any combination thereof.

13. A bis (arene) nickel complex, comprising a purity of 95% or greater,
wherein the bis (arene) nickel complex is purified by solvent extraction.

14. The bis (arene) nickel complex of claim 13, wherein the solvent extraction comprises extraction by a separation solvent comprising alkanes or aromatics.

15. The bis (arene) nickel complex of claim 13, wherein the solvent extraction comprises extraction by a separation solvent comprising pentane.

16. The bis (arene) nickel complex of claim 13, wherein the purity is 98% or greater.

17. The bis (arene) nickel complex of claim 13, comprising at least one impurity of 1.2% or less.

18. The bis (arene) nickel complex of claim 17, wherein the at least one impurity is detectable by nuclear magnetic resonance (NMR) spectroscopic analysis.

19. The bis (arene) nickel complex of claim 13, wherein the bis (arene) nickel complex comprises bis (cyclopentadiene) nickel.

20. The bis (arene) nickel complex of claim 13, wherein the bis (arene) nickel complex comprises bis (alkylcyclopentadiene) nickel, bis (methylcyclopentadiene) nickel, bis (ethylcyclopentadiene) nickel, bis (isopropylcyclopentadiene) nickel, bis (tert-butylcyclopentadiene) nickel, bis (pentamethylcyclopentadiene) nickel, or any isomer thereof.
